(19) United States
(12) Patent Application Publication
(10) Pub. No.: US 2015/0105212 A1
(43) Pub. Date: Apr. 16, 2015

(54) SYSTEM AND METHOD FOR SALVAGING A PIN-BORE ASSEMBLY

(71) Applicant: Caterpillar Inc., Peoria, IL (US)

(72) Inventors: Curtis J. Graham, Peoria, IL (US); Donald G. Clark, luka, MS (US); Deven J. Efta, Fargo, ND (US); Charles G. Leeper, West Fargo, ND (US); Jamie L. Krank, West Fargo, ND (US); Kristin A. Schipull, Moorhead, MN (US)

(73) Assignee: Caterpillar Inc., Peoria, IL (US)

(21) Appl. No.: 14/053,242

(22) Filed: Oct. 14, 2013

(51) Int. Cl. B23P 6/00; B23P 13/02; F16H 57/08

(52) U.S. Cl. CPC B23P 6/00; F16H 57/082; B23P 13/02
USPC 475/331; 156/80; 156/293; 29/402.14; 29/402.16; 29/402.12; 29/402.13

(57) ABSTRACT

A method for salvaging a surface of a pin-bore assembly associated with a carrier is provided. The method includes inserting a sleeve within a bore of the carrier. The method also includes installing a retention mechanism that secures the sleeve within the bore of the carrier.

### TECHNICAL FIELD

The present disclosure relates to a system and method for salvaging of wear prone surfaces, more particularly to the system and method for salvaging a pin-bore assembly of a carrier.

### BACKGROUND

A pin bore of a final drive carrier that is configured to receive a pin may be subjected to wear and tear. This may cause oversizing of a diameter of the bore which in turn leads to the carrier being unusable. Known salvaging methods for the bore of the carrier include heating the bore using a high temperature heat source. Heating the metal of the bore may expand a metal used to form the carrier, thereby decreasing the bore diameter. However, this salvaging method may allow the carrier to be reused only once.

U.S. Pat. No. 4,153,983 discloses a cylinder wall repair wherein worn or damaged areas of the cylinder are restored. The cylinder housing is re-bored and threaded or ground. An externally threaded or grooved sleeve member is then screwed or inserted into the cylinder housing. The internal configuration and dimensions of the sleeve member may be designed to duplicate that of the original cylinder. The thread or groove design provides tunnels between the sleeve member and the cylinder housing.

### SUMMARY OF THE DISCLOSURE

In one aspect of the present disclosure, a method for salvaging a surface of a pin-bore assembly associated with a carrier is provided. The method includes inserting a sleeve within a bore of the carrier. The method also includes installing a retention mechanism that secures the sleeve within the bore of the carrier.

In another aspect of the present disclosure, a carrier including a front wall and a rear wall is provided. The carrier also includes a pin-bore assembly provided on the front and rear walls of the carrier. Further, the pin-bore assembly includes a sleeve press fitted within a bore defined by an inner surface of the carrier. The pin-bore assembly also includes a retention mechanism that secures the sleeve within the bore of the carrier.

Other features and aspects of this disclosure will be apparent from the following description and the accompanying drawings.

### BRIEF DESCRIPTION OF THE DRAWINGS

FIG. 1 shows a perspective view of a carrier including cutting planes AA and BB, according to one embodiment of the present disclosure;

FIG. 2 shows a perspective view of a sleeve;

FIG. 3 shows a cut section of a pin-bore assembly of the carrier along the cutting plane BB;

FIG. 4 shows an exploded view along the cutting plane AA having the sleeve of FIG. 2 being inserted into the carrier;

FIGS. 5 and 6 show different assembled views of FIG. 4 along the cutting planes AA and BB respectively, wherein mechanical fasteners are provided as a retention mechanism for attaching the sleeve to the carrier, according to various embodiments of the present disclosure;

FIG. 7 shows a perspective view of another configuration of the sleeve;

FIG. 8 shows an exploded view along the cutting plane AA having the sleeve of FIG. 7 being inserted into the carrier;

FIG. 9 shows an assembled view of FIG. 8 along the cutting plane AA, including a weld bead for attaching the sleeve to the carrier; and

FIG. 10 shows a flowchart of a method for salvaging the pin-bore assembly of the carrier.

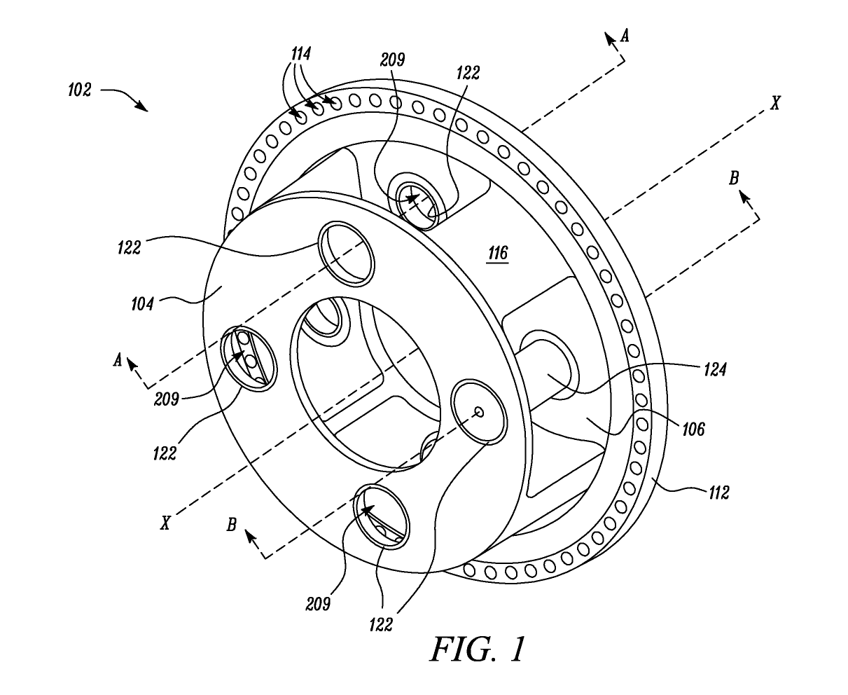

### DETAILED DESCRIPTION

Wherever possible, the same reference numbers will be used throughout the drawings to refer to the same or the like parts. FIG. 1 illustrates a perspective view of the carrier 102 according to an embodiment of the present disclosure. FIG. 1 includes cutting planes AA and BB. In the illustrated embodiment, the carrier 102 has a circular configuration. The carrier 102 may be used in a final drive assembly (not shown) associated with an engine assembly (not shown). The carrier 102 includes a front wall 104. In one embodiment, the carrier 102 may also include a rear wall 106. Further, the rear wall 106 of the carrier 102 may include a circumferential extension 112. The extension 112 may have a plurality of holes 114 provided along a circumference of the extension 112 in order to attach the carrier 102 to another engine component.

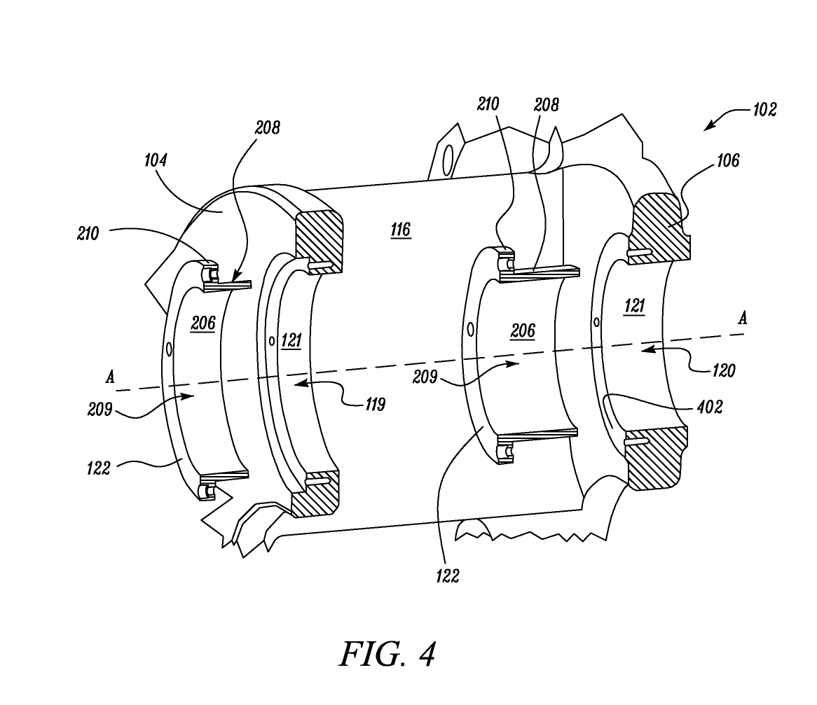

The front and rear walls 104, 106 of the carrier 102 may be connected by a plurality of axial projections 116. The projections 116 are provided along an axis XX defined by the carrier 102. The carrier 102 also includes a central bore provided along the axis XX. The central bore may be configured to receive a shaft (not shown) of the final drive assembly. The front and rear walls 104, 106 of the carrier 102 include a first bore 119 (see FIG. 4) and a second bore 120 (see FIG. 4) respectively. Further, the first and second bores 119, 120 on the walls 104, 106 of the carrier 102 are coaxial. The carrier 102 includes an inner surface 121 (see FIG. 4) defining the first and second bores 119, 120 of the carrier 102. Referring to FIG. 1, a sleeve 122 is provided within the first and second bores 119, 120 of the carrier 102. A pin 124 may be received into the sleeve 122. Only one pin 124 is illustrated in FIG. 1 merely for the purpose of clarity.

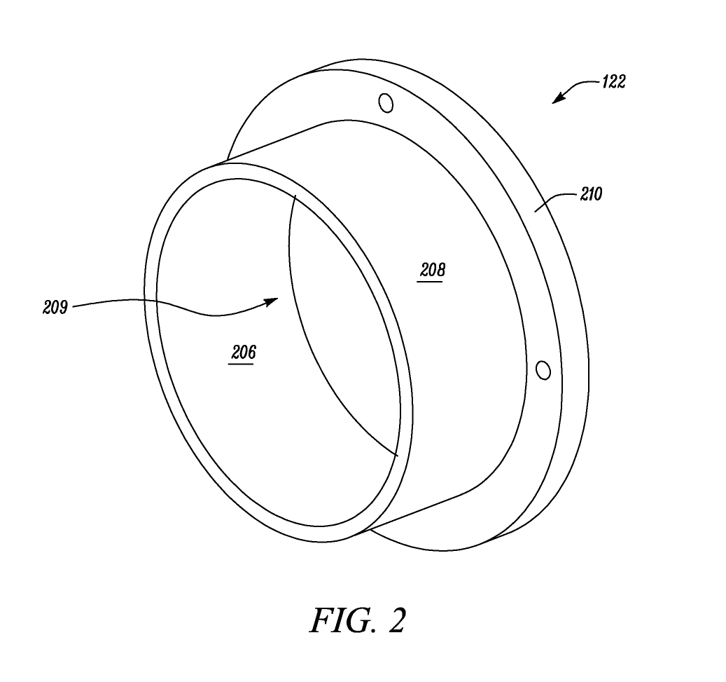

FIG. 2 is a perspective view of the sleeve 122, according to one embodiment of the present disclosure. In one embodiment, the sleeve 122 may have a hollow cylindrical configuration. The sleeve 122 includes an inner surface 206 and an outer surface 208. The inner surface 206 of the sleeve 122 defines a pin bore 209, such that the pin bore 209 is configured to receive the pin 124. The sleeve 122 may include a flange 210 extending from one end of the sleeve 122. It should be noted that the sleeve 122 may be made from any metal known in the art.

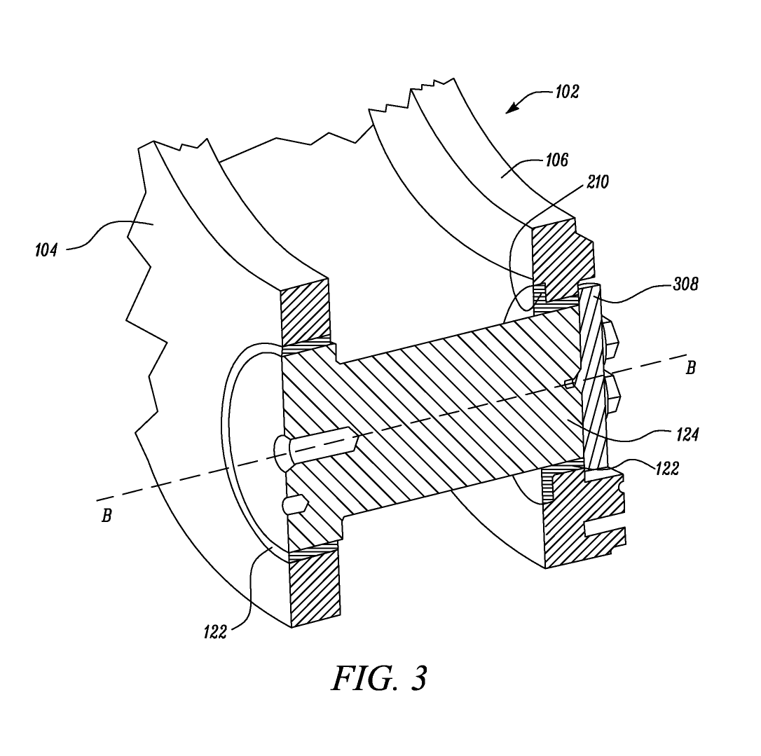

FIG. 3 illustrates a cut section along the cutting plane BB showing a pin-bore assembly of the carrier 102. The pin-bore assembly includes the sleeve 122 inserted within the first and second bores 119, 120. The pin 124 is positioned within the pin bore 209 defined by the inner surface 206 of the sleeve 122. In one embodiment, a bearing (not shown) may be located surrounding the pin 124. Prior to assembly of the sleeve 122, the first and second bores 119, 120 (see FIG. 4) of the carrier 102 are appropriately machined to cooperate with the outer surface 208 of the sleeve 122.

As shown in FIG. 3, after assembly, the sleeve 122 is positioned between the pin 124 and the first and second bores 119, 120 of the carrier 102 or at an interface of the pin 124 and the inner surface 121 of the carrier 102 in a manner such that the sleeve 122 may serve as a sacrificial surface during installation or removal of the pin 124. It should be noted that the shape of the sleeve 122 positioned at the front and rear walls 104, 106 of the carrier 102 may be different in order to accommodate the pin 124. In the illustrated embodiment, the sleeve 122 on the front wall 104 of the carrier 102 has a substantially hollow cylindrical configuration. Whereas, the sleeve 122 on the rear wall 106 has a hollow cylindrical configuration with the flange 210 extending from one end of the sleeve 122. As seen in the accompanying figure, the first bore 119 on the front wall 104 of the carrier 102 may have an enlarged diameter compared to that of the second bore 120 provided on the rear wall 106 of the carrier 102 in order to cooperate with and receive a stepped portion of the pin 124.

Moreover, a plate 308 may be bolted onto either the front and/or rear walls 104, 106 of the carrier 102 in order to securely fix the pin 124 inside the pin bore 209 defined by the sleeve 122. In one embodiment, the plate 308 may have a circular configuration. It should be noted that the plate 308 may have a diameter greater than that of the diameter of the first and second bores 119, 120 such that the plate 308 covers a circumference of the pin 124 and the sleeve 122 when assembled. In one embodiment, a thrust plate 402 (see FIG. 4) may be attached to a surface of the front and/or rear walls 104, 106 of the carrier 102 for contacting with the bearing. Based on the location of the thrust plate 402 on the carrier 102, the flange 210 of the sleeve 122 may rest on the thrust plate 402 in order to reinforce the thrust plate 402. In this situation, as shown in FIG. 3, the flange 210 associated with the sleeve 122 may come in contact with the bearing and act as a thrust face for the bearing.

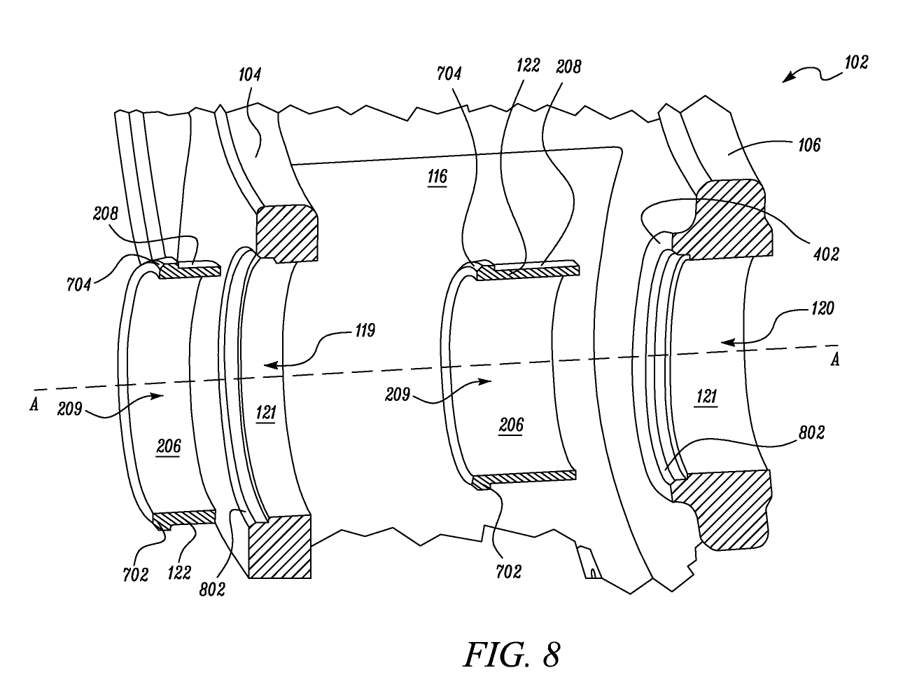

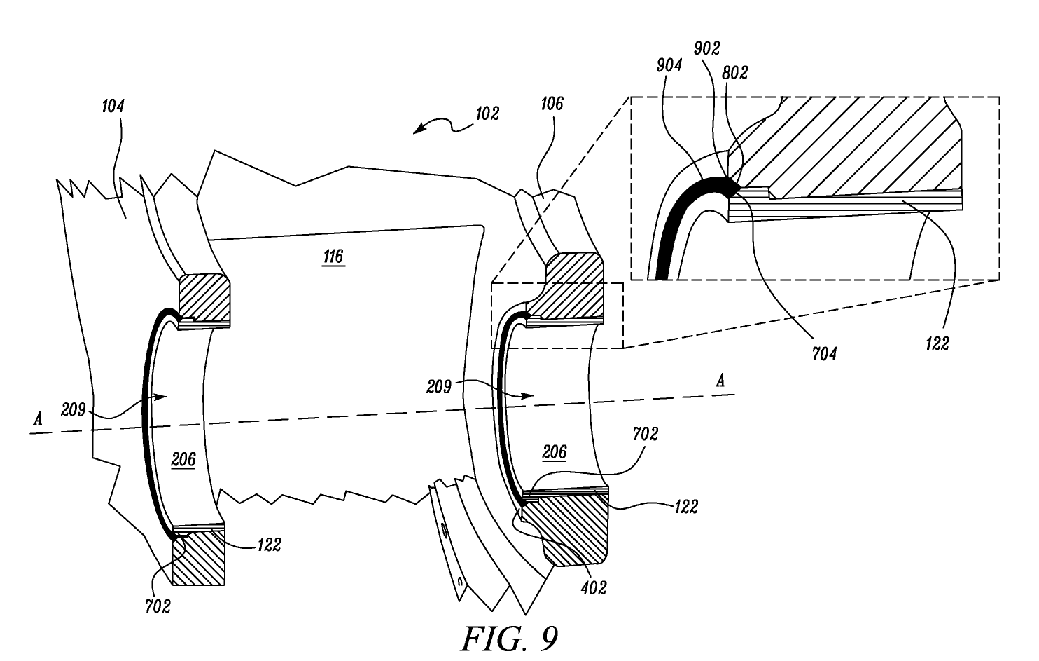

In the present disclosure, the sleeve 122 is press fitted between the first and second bores 119, 120 of the carrier 102 and the pin 124. Also, a retention mechanism is provided to secure the sleeve 122 within the first and second bores 119, 120 of the carrier 102. The retention mechanism is configured to hold the sleeve 122 within the first and second bores 119, 120 of the carrier 102 during the installation or the removal of the pin 124. Different retention mechanisms include providing mechanical fasteners 502 (explained in connection with FIGS. 4 to 6) and welding (explained in connection with FIGS. 8 and 9), according to various embodiments of the present disclosure.

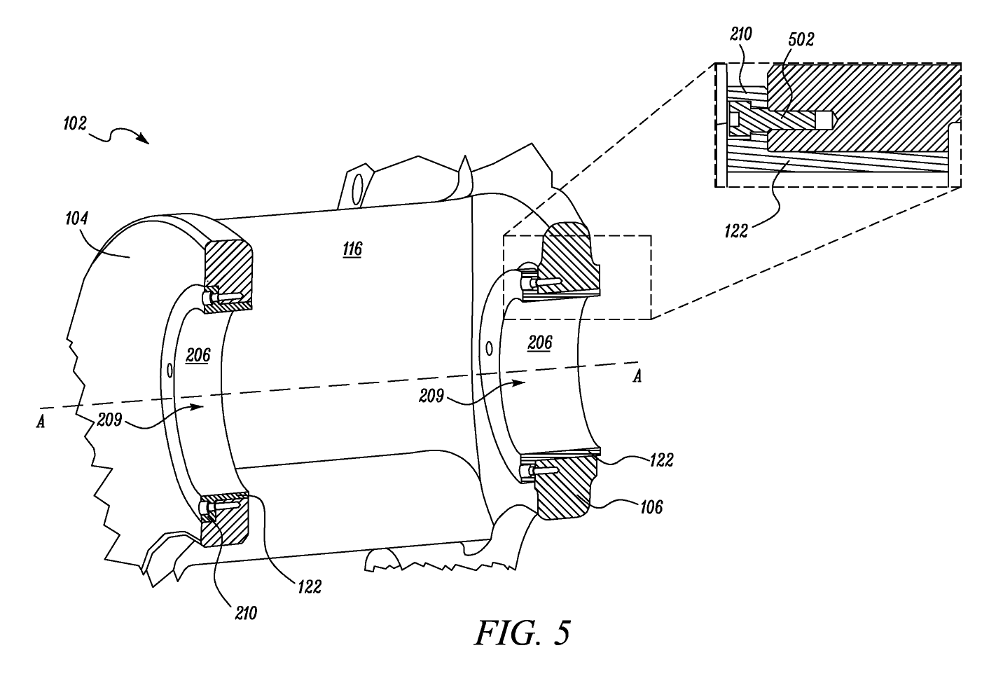

FIG. 4 shows a cut section along the cutting plane AA depicting an exploded view of the sleeves 122 associated with the front and rear walls 104, 106 of the carrier 102 respectively. As is clearly visible, the inner surface 121 of the front and rear walls 104, 106 of the carrier 102 define the first and second bores 119, 120 respectively therein. In the illustrated embodiment, the first bore 119 on the front wall 104 of the carrier 102 is machined to a certain depth in order to receive the flange 210 of the sleeve 122. One of ordinary skill in the art will appreciate that any of the front or rear walls 104, 106 may be appropriately machined for cooperating with a shape of the sleeve 122 to be inserted therein. Further, the thrust plate 402 is provided on the rear wall 106 of the carrier 102. FIG. 5 shows the assembled cut section view along the plane AA including the sleeve 122 fitted within the first and second bores 119, 120 of the carrier 102. When assembled, the flange 210 of the sleeve 122 is configured to rest on the thrust plate 402. As mentioned earlier, the sleeve 122 may be retained within the first and second bores 119, 120 using the mechanical fasteners 502 as the retention mechanism. The sleeve 122 may include a number of holes provided circumferentially on the flange 210 corresponding to holes provided on the carrier 102 for receiving the mechanical fasteners 502. The mechanical fasteners 502 may include a bolt, stud, rivet, and the like.

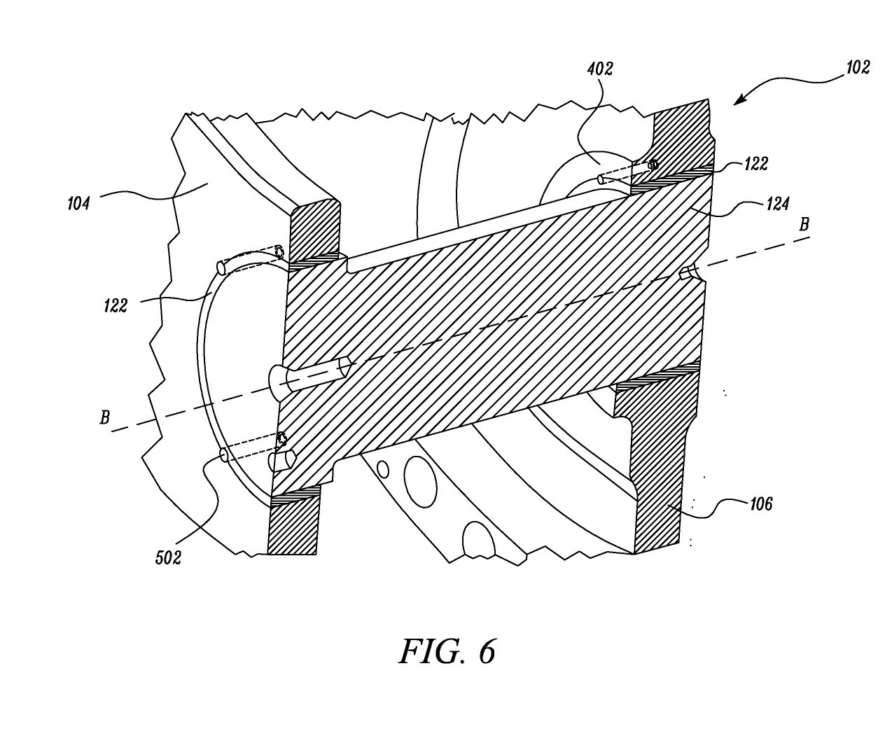

FIG. 6 shows another arrangement of the mechanical fastener 502 along the cutting plane BB. The design of the sleeve 122 in this figure is different from that shown in FIGS. 2, 4 and 5. More particularly, the sleeve 122 may have a hollow cylindrical configuration. Also, the positioning of the mechanical fasteners 502 is different from that shown in FIG. 5. An outer periphery of the sleeve 122 may include the holes in such a manner that a diameter of the hole is partially provided on the outer periphery of the sleeve 122 and a remaining portion of the hole is provided on the carrier 102. The plurality of holes on the sleeve 122 and the walls 104, 106 of the carrier 102 are configured to receive the mechanical fastener 502, such as, for example, a set screw.

In one embodiment, an adhesive may be applied on the outer surface 208 of the sleeve 122 prior to insertion of the sleeve 122 into the first and second bores 119, 120 of the carrier 102. Similarly, the adhesive may also be applied on the inner surface 121 of the carrier 102 which is configured to receive the sleeve 122. It should be noted that the adhesive is applied to freeze the sleeve 122 prior to the insertion for attaining the desired press fit between the first or second bores 119, 120 and the sleeve 122. In another embodiment, the adhesive may be provided on an outer surface of the mechanical fastener 502. Additionally, the adhesive may be applied on an inner surface of the holes provided on the sleeve 122 and the front and/or rear walls 104, 106 of the carrier 102 for holding the mechanical fastener 502 in position therein.

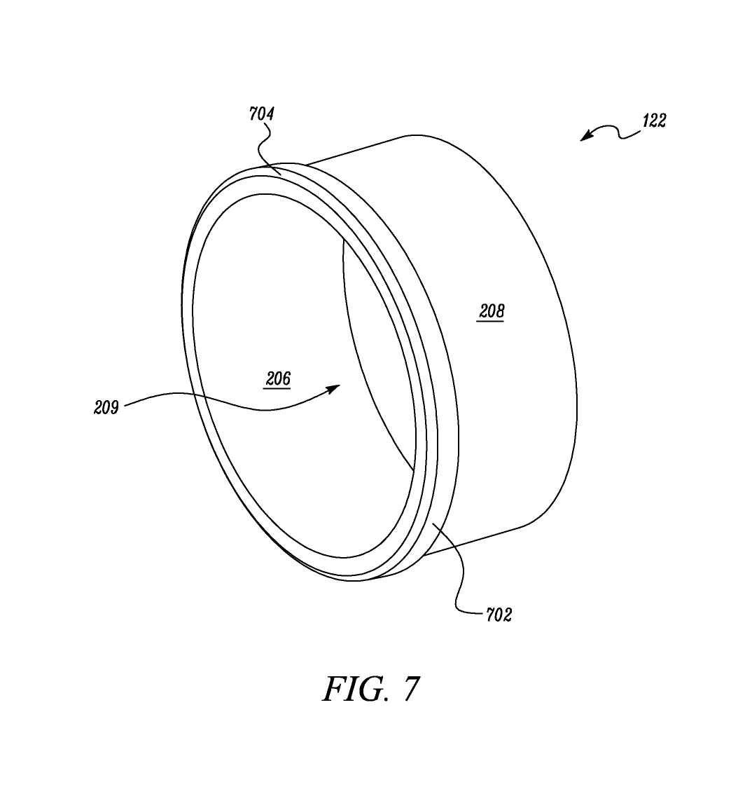

FIG. 7 is a perspective view of another design of the sleeve 122, according to one embodiment of the present disclosure. In this design, the sleeve 122 includes a stepped portion 702. The sleeve 122 also includes a beveled surface 704 machined on an outer periphery of the stepped portion 702.

FIG. 8 is an exploded view along the cutting plane AA showing the carrier 102 and the sleeve 122 depicted in FIG. 7. In the embodiment illustrated in FIGS. 8 and 9, the retention mechanism includes welding the sleeve 122 to the front and rear walls 104, 106 of the carrier 102. Referring to FIG. 8, the inner surface 121 of the carrier 102 is shaped to receive the sleeve 122. More particularly, the inner surface 121 of the carrier 102 also includes a beveled surface 802 machined along an edge of the front and rear walls 104, 106 of the carrier 102 to cooperate with the beveled surface 704 of the sleeve 122.

FIG. 9 shows an assembled view of the arrangement of FIG. 8 provided along the cutting plane AA. The sleeve 122 is provided within the carrier 102 such that the beveled surfaces 704, 802 of the sleeve 122 and the carrier 102 form a groove 902 configured to receive a weld bead 904 for welding the sleeve 122 with the carrier 102. After the sleeve 122 is press fitted into the carrier 102, a diameter of the pin bores 209 defined by the inner surface 206 of the sleeve 122 on the front and rear walls 104, 106 respectively may be aligned for receiving the pin 124.

### INDUSTRIAL APPLICABILITY

The bores of the carrier may get oversized due to wear and tear, thereby rendering the carrier as unusable. Known salvaging methods include using a high temperature heat source to heat the oversized bore to cause a reduction in diameter of the bore for re-use. However, employing such methods allows for the re-use of the carrier only once.

A system and method for salvaging the first and second bores 119, 120 of the carrier 102 is disclosed herein. The sleeve 122 is press fitted between the first and second bores 119, 120 of the carrier 102 and the pin 124. The pin 124 may be received into the pin bore 209 defined by the sleeve 122. Further, the retention mechanism is provided to hold the sleeve 122 in place during the installation and the removal of the pin 124. In a situation wherein the pin bore 209 of the sleeve 122 may get oversized, the sleeve 122 may be replaced. Hence, the first and second bores 119, 120 of the carrier 102 may remain protected or intact, allowing for multiple re-use.

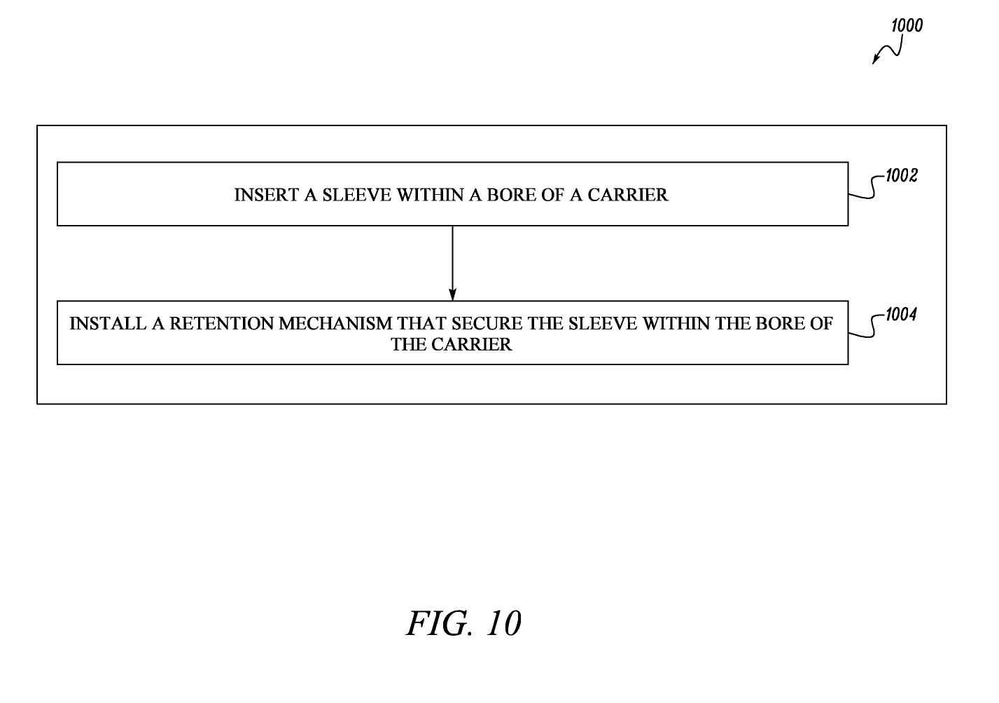

FIG. 10 illustrates a method 1000 for salvaging the surface of the pin-bore assembly associated with the carrier 102. At step 1002, the sleeve 122 is inserted within the first and second bores 119, 120 of the carrier 102. The first and second bores 119, 120 of the carrier 102 are machined prior to the insertion in order to receive the sleeve 122 so that the outer surface 208 of the sleeve 122 conforms to the first and second bores 119, 120.

Further, in one embodiment, the adhesive is provided on the inner surface 121 of the carrier 102 to control the press fit between the sleeve 122 and the first and second bores 119, 120 of the carrier 102. In another embodiment, the adhesive may be provided on the outer surface 208 of the sleeve 122 prior to insertion within the first and second bores 119, 120. The sleeve 122 may be frozen before inserting the sleeve 122 within the first and second bores 119, 120 of the carrier 102 in order to control the press fit between the sleeve 122 and the first and second bores 119, 120 of the carrier 102.

At step 1004, the retention mechanism associated with the sleeve 122 is installed. As explained earlier, the retention mechanism is provided in order to secure the sleeve 122 within the first and second bores 119, 120 of the carrier 102 during the installation or the removal of the pin 124. In one embodiment, the holes may be provided on the outer periphery of the flange 210 and the walls 104, 106 of the carrier 102 respectively. The holes are configured to receive the mechanical fasteners 502 for affixing the sleeve 122 onto the carrier 102. In another embodiment, the holes are provided partially on the outer periphery of the sleeve 122 and partially on the walls 104, 106 of the carrier 102.

Further, in order to provide a better fastening, the adhesive may be applied on the mechanical fasteners 502 prior to insertion within the holes of the sleeve 122 and carrier 102. The adhesive may also be applied within the holes of the sleeve 122 and/or the carrier 102. It should be noted that the adhesive may be used to increase retention strength between the sleeve 122 and the first and second bores 119, 120 of the carrier 102.

An alternative retention mechanism may also be utilized such that the weld bead 904 may be provided within the groove 902 defined along the edge of the walls 104, 106 of the carrier 102 and the sleeve 122. Further, the pin bore 209 defined by the sleeve 122 on the front wall 104 of the carrier 102 and the corresponding pin bore 209 on the rear wall 106 of the carrier 102 is aligned. The pin bores 209 may be aligned in order to receive the pin 124. The aligning of the pin bores 209 may includes machining the inner surface 206 of the sleeves 122 installed on the front and rear walls 104, 106 of the carrier 102, such that the diameters of the pin bores 209 on the respective walls 104, 106 are coaxial and cooperate with one another for receiving the pin 124.

Additional machining of the sleeve 122 and/or the walls 104, 106 may be performed for final shaping and cooperation with the carrier 102. For example, after the installation of the sleeve 122 therein, the front and rear walls 104, 106 and the sleeve 122 may be machined in order to remove excessive material and form a smooth surface on the respective walls 104, 106.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for salvaging a surface of a pin-bore assembly associated with a carrier comprising:
inserting a sleeve within a bore of the carrier, the carrier having a front wall and an axially spaced rear wall; and
installing a retention mechanism that secures the sleeve within the bore of the carrier.

2. The method of claim 1, wherein the bore of the carrier includes a first bore through the front wall of the carrier, and a second bore through the rear wall of the carrier, the first and second bores being coaxial.

3. The method of claim 1 further comprising:
machining the bore of the carrier to receive the sleeve.

4. The method of claim 1, wherein the inserting step includes:
applying an adhesive on an inner surface of the bore of the carrier; and
freezing the sleeve prior to insertion within the bore to create a press fit.

5. The method of claim 1, wherein the installing step includes affixing the sleeve to the carrier by a fastener through one or more holes on a. flange extending from one end of the sleeve.

6. The method of claim 5, wherein the holes in the flange are at least partially along an outer periphery of the flange.

7. The method of claim 5, wherein the affixing step includes applying the adhesive on a surface of the fastener for holding the fastener within the provided hole.

8. The method of claim 1, wherein the installing step includes creating a weld bead within a groove positioned along the wall of the carrier.

9. The method of claim 1 further comprising:
machining a pin bore defined by an inner surface of the sleeve.

10. The method of claim 9 further comprising:
introducing a pin into the pin bore.

11. The method of claim 1 further comprising:
machining the sleeve to cooperate with the carrier.

12. A carrier comprising:
a front wall;
a rear wall; and
a pin-bore assembly positioned in the front and rear walls of the carrier, the assembly comprising:
a sleeve press fit within a bore in the wall of the carrier; and
a retention mechanism that secures the sleeve within the bore of the carrier.

13. The carrier of claim 12, wherein the wall of the carrier is machined to cooperate with the sleeve.

14. The carrier of claim 12, wherein the sleeve is generally cylindrical.

15. The carrier of claim 14, wherein the sleeve includes a flange extending from one end.

16. The carrier of claim 15, wherein the retention mechanism includes fasteners extending through holes in the flange of the sleeve for attaching the sleeve to the wall of the carrier.

17. The carrier of claim 15, wherein the retention mechanism includes fasteners extending through holes positioned at least partially on an outer periphery of the flange and at least partially through the wall of the carrier.

18. The carrier of claim 12, wherein the retention mechanism includes a weld bead provided within a groove positioned along an edge of the wall of the carrier.

19. The carrier of claim 12, wherein each of the front and rear walls includes a pin-bore assembly, each pin-bore assembly having a pin bore, the pin bores of the front and rear walls being coaxial with one another.
